(19) United States
(12) Patent Application Publication
(10) Pub. No.: US 2025/0079083 A1
(43) Pub. Date: Mar. 6, 2025

(54) DIELECTRIC, CAPACITOR, ELECTRICAL CIRCUIT, CIRCUIT BOARD, APPARATUS, AND ENERGY STORAGE DEVICE

(71) Applicant: Panasonic Intellectual Property Management Co., Ltd., Osaka (JP)

(72) Inventors: Hiroyuki KOSHIKAWA, Osaka (JP); Hiroki TAKEUCHI, Osaka (JP); Ryosuke KIKUCHI, Osaka (JP)

(21) Appl. No.: 18/949,304

(22) Filed: Nov. 15, 2024

Related U.S. Application Data
(63) Continuation of application No. PCT/JP2023/017191, filed on May 2, 2023.

(30) Foreign Application Priority Data
May 20, 2022 (JP) 2022-082824

(51) Int. Cl. H01G 4/12; H01G 4/08; H01G 4/33; H01G 9/032; H01G 9/07

(52) U.S. Cl. CPC H01G 4/1218; H01G 4/085; H01G 4/33; H01G 9/032; H01G 9/07

(57) ABSTRACT

A dielectric has a composition represented by Bi₂ₓMg_{y}Ti_{z}Oₖ. The composition satisfies requirements x≥0.15, y≥0.40, z≥0.25, and x+y+z=1.0. In the composition, k is a value for maintaining electroneutrality.

This application is a continuation of PCT/JP2023/017191 filed on May 2, 2023, which claims foreign priority of Japanese Patent Application No. 2022-082824 filed on May 20, 2022, the entire contents of both of which are incorporated herein by reference.

### BACKGROUND OF THE INVENTION

### 1. Field of the Invention

The present disclosure relates to a dielectric, a capacitor, an electrical circuit, a circuit board, an apparatus, and an energy storage device.

### 2. Description of Related Art

Capacitors using ceramics have been known. For example, JP 2000-058378 A describes a multilayer ceramic capacitor including a ceramic dielectric layer in which an oxide having Ba, Ca, and Ti is included.

JP 2018-531858 A describes a dielectric composition including a perovskite-type crystal structure in which at least Bi, Na, Sr, and Ti are included. The dielectric composition includes specific particles having a core-shell structure that has at least one core portion including SrTiO₃. The dielectric composition can form the dielectric layer of a multilayer ceramic capacitor.

JP 2010-278430 A describes a capacitor having an insulating structure including a polymer layer and a composite layer. The composite layer is disposed on the polymer layer and includes a thermoplastic polymer including at least one inorganic component. This capacitor can be utilized for power conversion at high energy densities.

Journal of Materials Chemistry C, 2019, vol. 7, pp. 13632-13639 describes perovskite thin Bi(Mg_{0.5}Tiₓ)O₃ films, where x is 0.50 to 0.85.

Journal of the European Ceramic Society, 2020, vol. 40, pp. 1243-1249 describes BiMg_{y}Ti_{0.5}O₃ films, where y is 0.50 to 0.62.

### SUMMARY OF THE INVENTION

The techniques described in the above literatures leave room for reexamination from the viewpoint of increasing the capacitance of a capacitor under conditions of high electric field strength. In view of this, the present disclosure provides a novel dielectric that is advantageous for increasing the capacitance of a capacitor under conditions of high electric field strength.

A dielectric of the present disclosure has a composition represented by Bi₂ₓMg_{y}Ti_{z}Oₖ, wherein
the composition satisfies requirements x≥0.15, y≤0.40, z≥0.25, and x+y+z=1.0, and
in the composition, k is a value for maintaining electroneutrality.

According to the present disclosure, it is possible to provide a novel dielectric that is advantageous for increasing the capacitance of a capacitor under conditions of high electric field strength.

### BRIEF DESCRIPTION OF THE DRAWINGS

FIG. 1 is a cross-sectional view showing an example of a capacitor of the present disclosure.

FIG. 2 is a cross-sectional view showing another example of the capacitor of the present disclosure.

FIG. 3A schematically shows an example of an electrical circuit of the present disclosure.

FIG. 3B schematically shows an example of a circuit board of the present disclosure.

FIG. 3C schematically shows an example of an apparatus of the present disclosure.

FIG. 3D schematically shows an example of an energy storage device of the present disclosure.

FIG. 4 shows the X-ray diffraction (XRD) patterns of dielectric films according to Examples 1 to 5.

FIG. 5 shows the XRD patterns of dielectric films according to Comparative Examples 2 to 7.

### DETAILED DESCRIPTION

### (Findings Underlying the Present Disclosure)

In recent years, along with the miniaturization of apparatuses and the increase in operating voltages thereof, electronic components in electrical circuits are similarly required for miniaturization and increase in operating voltages. It is considered that, for example, providing a compact capacitor capable of exhibiting a high capacitance under conditions of high electric field strength can contribute to the miniaturization of apparatuses and the increase in operating voltages thereof.

Barium titanate and its derivatives have been used as dielectrics in capacitors. For example, multilayer ceramic capacitors are in widespread use. Since the capacitance of capacitors with the same shape is proportional to the dielectric constant of the dielectric, increasing the dielectric constant of the dielectric leads to miniaturization and higher capacitance of capacitors. For example, high-permittivity multilayer ceramic capacitors can have a dielectric constant of 1000 or more, which is very high.

According to JP 2000-058378 A, it is understood that a dielectric containing barium titanate as a basis and having a given amount of a specific oxide added has a dielectric constant of 1000 or more under conditions where no DC voltage is applied. Furthermore, the multilayer ceramic capacitor described in JP 2000-058378 A is understood to have a decreased rate of capacitance change in the application of a DC voltage at an electric field strength of 5 kV/mm. The dielectric composition described in JP 2018-531858 A is understood to have a dielectric constant of 1000 or more under conditions where no DC voltage is applied. In addition, the dielectric composition described in JP 2018-531858 A is understood to exhibit a low rate of capacitance change between before and after application of a DC bias of 5 V/μm.

On the other hand, for example, in automotive converters and automotive inverters, snubber capacitors and smoothing capacitors can be subjected to application of high DC voltages of several hundred volts. To achieve miniaturization of capacitors intended for use under conditions where high DC voltages are applied, it is considered crucial to increase the capacitance of capacitors at electric field strengths higher than the electric field strengths in the evaluations of the rate of capacitance change in JP 2000-058378 A and JP 2018-531858 A.

The insulating structure of the capacitor described in JP 2010-278430 A has a permittivity of approximately 3 to approximately 100 and a breakdown strength of approximately 150 kV/mm. While this insulating structure has high breakdown strength, its dielectric constant is understood to be not so high due to the inclusion of the polymer layer. In addition, JP 2010-278430 A does not evaluate the dielectric constant of the insulating structure at high electric field strengths near the breakdown strength.

According to the descriptions in Journal of Materials Chemistry C, 2019, vol. 7, pp. 13632-13639 and Journal of the European Ceramic Society, 2020, vol. 40, pp. 1243-1249, it is understood that in the synthesis of bismuth magnesium titanate, adding an excess amount of titanium or magnesium decreases the saturation polarization density but increases the dielectric breakdown strength, thereby increasing the capacitance of the material. On the other hand, no evaluation is performed for the dielectric constants of the thin Bi(Mg_{0.5}Tiₓ)O₃ films and the BiMg_{y}Ti_{0.5}O₃ films at high electric field strengths respectively in Journal of Materials Chemistry C, 2019, vol. 7, pp. 13632-13639 and Journal of the European Ceramic Society, 2020, vol. 40, pp. 1243-1249.

In view of such circumstances, the present inventors have made intensive studies in order to develop a novel dielectric that is advantageous for increasing the capacitance of a capacitor under conditions of high electric field strength. Through much trial and error, the present inventors have gained a novel finding on the relationship between the content of Bi, Mg, and Ti in an oxide including Bi, Mg, and Ti and the properties of a dielectric at high electric field strengths. On the basis of this novel finding, the present inventors have devised a dielectric of the present disclosure.

### (Outline of One Aspect According to the Present Disclosure)

A dielectric according to a first aspect of the present disclosure has a composition represented by Bi₂ₓMg_{y}Ti_{z}Oₖ, wherein
the composition satisfies requirements x≥0.15, y≤0.40, z≥0.25, and x+y+z=1.0, and
in the composition, k is a value for maintaining electroneutrality.

According to the first aspect, the dielectric is likely to have an increased dielectric constant under conditions of high electric field strength. Therefore, the dielectric is advantageous for increasing the capacitance of a capacitor under conditions of high electric field strength.

In a second aspect of the present disclosure, for example, the dielectric according to the first aspect may include crystalline Bi₂Ti₂O₇. According to the second aspect, the dielectric is more likely to have an increased dielectric constant under conditions of high electric field strength, and this is advantageous for increasing the capacitance of a capacitor under conditions of high electric field strength.

In a third aspect of the present disclosure, for example, the dielectric according to the first or second aspect may include at least one selected from the group consisting of crystalline Bi₄Ti₃O₁₂, crystalline γ—Bi₂O₃, and crystalline Bi(Mg_{0.5}Ti_{0.5})O₃. According to the third aspect, the dielectric is more likely to have an increased dielectric constant under conditions of high electric field strength. Therefore, the dielectric is more advantageous for increasing the capacitance of a capacitor under conditions of high electric field strength.

In a fourth aspect of the present disclosure, for example, the dielectric according to any one of the first to third aspects may include at least one selected from the group consisting of crystalline Bi₄Ti₃O₁₂ and crystalline γ—Bi₂O₃. According to the fourth aspect, the dielectric is more likely to have an increased dielectric constant under conditions of high electric field strength. Therefore, the dielectric is more advantageous for increasing the capacitance of a capacitor under conditions of high electric field strength.

In a fifth aspect of the present disclosure, for example, the dielectric according to any one of the first to third aspects may include crystalline γ—Bi₂O₃. According to the fifth aspect, the dielectric is more likely to have an increased dielectric constant under conditions of high electric field strength. Therefore, the dielectric is more advantageous for increasing the capacitance of a capacitor under conditions of high electric field strength.

In a sixth aspect of the present disclosure, for example, the dielectric according to any one of the first to fifth aspects may have, at an electric field strength of 0.5 MV/cm, a dielectric constant of more than 138 when the electric field strength is increased.

Furthermore, the dielectric may have, at an electric field strength of 0.5 MV/cm, a dielectric constant of more than 100 when the electric field strength is decreased.

According to the sixth aspect, the dielectric is more advantageous for increasing the capacitance of a capacitor under conditions of high electric field strength.

In a seventh aspect of the present disclosure, for example, the dielectric according to any one of the first to sixth aspects may have, at an electric field strength of 0.7 MV/cm, a dielectric constant of more than 138 when the electric field strength is increased. Furthermore, the dielectric may have, at an electric field strength of 0.7 MV/cm, a dielectric constant of more than 57 when the electric field strength is decreased. According to the seventh aspect, the dielectric is more advantageous for increasing the capacitance of a capacitor under conditions of high electric field strength.

In an eighth aspect of the present disclosure, for example, the dielectric according to any one of the first to seventh aspects may form at least one film selected from the group consisting of a pulsed laser deposition film, a vacuum deposition film, a sputtering film, an atomic layer deposition film, a chemical vapor deposition film, and an anodic oxide film. According to the eighth aspect, the dielectric can be present as a film such as a pulsed laser deposition film, and is therefore advantageous for increasing the capacitance of a capacitor.

In a ninth aspect of the present disclosure, for example, the dielectric according to any one of the first to eighth aspects may be for a capacitor. According to the ninth aspect, the dielectric can be used to increase the capacitance of a capacitor under conditions of high electric field strength.

A capacitor according to a tenth aspect of the present disclosure include:
a first electrode;
the dielectric according to any one of the first to ninth aspects disposed on the first electrode; and
a second electrode covering at least a portion of the dielectric.

According to the tenth aspect, the capacitor is likely to have an increased capacitance under conditions of high electric field strength.

An electrical circuit according to an eleventh aspect of the present disclosure includes the capacitor according to the tenth aspect. According to the eleventh aspect, the electrical circuit is likely to exhibit a desired performance when the capacitor is used under conditions of high electric field strength.

A circuit board according to a twelfth aspect of the present disclosure includes the capacitor according to the tenth aspect. According to the twelfth aspect, the circuit board is likely to exhibit a desired performance when the capacitor is used under conditions of high electric field strength.

An apparatus according to a thirteenth aspect of the present disclosure includes the capacitor according to the tenth aspect. According to the thirteenth aspect, the apparatus is likely to exhibit a desired performance when the capacitor is used under conditions of high electric field strength.

An energy storage device according to a fourteenth aspect of the present disclosure includes the capacitor according to the tenth aspect. According to the fourteenth aspect, the energy storage device is likely to exhibit a desired performance when the capacitor is used under conditions of high electric field strength.

### Embodiments

Embodiments of the present disclosure are described below with reference to the drawings. The embodiments described below each represent a comprehensive or specific example. Accordingly, the numerical values, shapes, materials, constituent elements, arrangement and connection of the constituent elements, etc. shown in the embodiments below are only exemplary and are not intended to limit the present disclosure. Furthermore, among the constituent elements in the embodiments below, any constituent elements that are not recited in the independent claims each representing the broadest concept are described as optional constituent elements. Moreover, duplicated descriptions of constituent elements assigned the same reference characters in the drawings may be omitted. Additionally, the constituent elements are schematically illustrated in the drawings for easy understanding, and the shape, dimensional ratio, etc. are not necessarily depicted accurately.

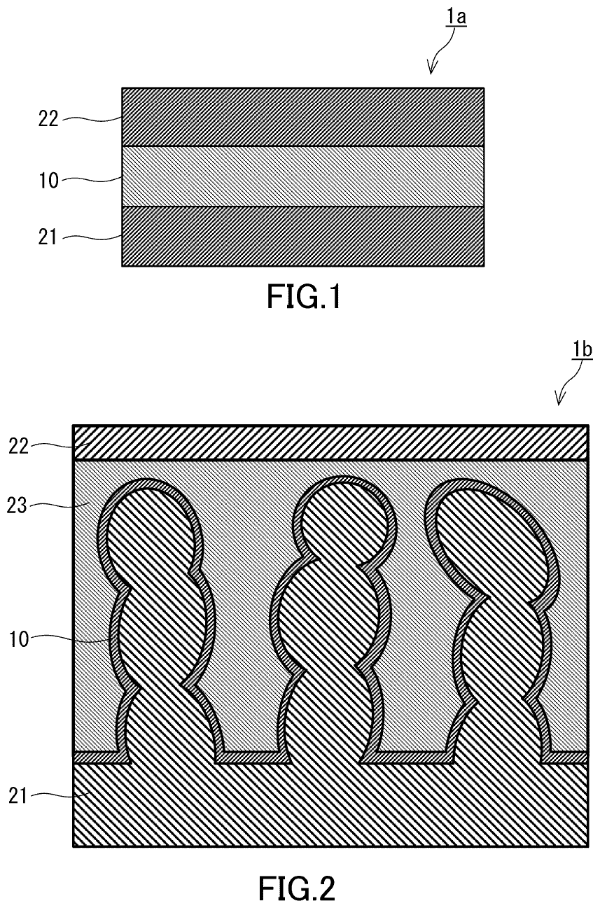

FIG. 1 is a cross-sectional view of an example of a capacitor of the present disclosure. As shown in FIG. 1, a capacitor 1a includes a dielectric 10. In other words, the dielectric 10 is a material for a capacitor. The dielectric 10 has a composition represented by Bi₂ₓMg_{y}Ti_{z}Oₖ. This composition satisfies requirements x≥0.15, y≤0.40, z≥0.25, and x+y+z=1.0. In this composition, k is a value for maintaining electroneutrality. With such a configuration, the dielectric 10 is likely to have an increased dielectric constant under conditions of high electric field strength. Therefore, the dielectric 10 is advantageous for increasing the capacitance of the capacitor 1a under conditions of high electric field strength.

The dielectric 10 includes, for example, crystalline Bi₂Ti₂O₇. With such a configuration, the dielectric 10 is more likely to have an increased dielectric constant under conditions of high electric field strength, and this is more advantageous for increasing the capacitance of the capacitor 1a under conditions of high electric field strength.

It is not always the case that the dielectric includes crystalline Bi₂Ti₂O₇ when the dielectric satisfies the above compositional requirements. According to the XRD patterns of the thin Bi(Mg_{0.5}Tiₓ)O₃ films described in Journal of Materials Chemistry C, 2019, vol. 7, pp. 13632-13639 and the BiMg_{y}Ti_{0.5}O₃ films described in Journal of the European Ceramic Society, 2020, vol. 40, pp. 1243-1249, these films are understood not to include crystalline Bi₂Ti₂O₇. On the other hand, according to the studies made by the present inventors, even for a dielectric including crystalline Bi₂Ti₂O₇, when the above compositional requirements are not satisfied, the dielectric 10 is less likely to have an increased dielectric constant under conditions of high electric field strength. In the dielectric 10, the above compositional requirements and the inclusion of crystalline Bi₂Ti₂O₇ are both satisfied. Therefore, the dielectric 10 is more likely to have an increased dielectric constant under conditions of high electric field strength.

In the above composition, a requirement x≤0.65 may be satisfied, a requirement x≤0.60 may be satisfied, a requirement x≤0.55 may be satisfied, and a requirement x≤0.50 may be satisfied. In the above composition, a requirement x≤0.45 may be satisfied, and a requirement x≤0.40 may be satisfied. In the above composition, for example, a requirement 0.15≤x≤0.65, 0.15≤x≤0.60, 0.15≤x≤0.55, 0.15≤x≤0.50, 0.15≤x≤0.45, or 0.15≤x≤0.40 is satisfied.

In the above composition, a requirement y≥0.05 may be satisfied, a requirement y≥0.10 may be satisfied, a requirement y≥0.15 may be satisfied, and a requirement y≥0.20 may be satisfied. In the above composition, for example, a requirement 0.05≤y≤0.40, 0.10≤y≤0.40, 0.15≤y≤0.40, or 0.20≤y≤0.40 is satisfied.

In the above composition, a requirement z≤0.80 may be satisfied, a requirement z≤0.75 may be satisfied, a requirement z≤0.70 may be satisfied, a requirement z≤0.65 may be satisfied, and a requirement z≤0.60 may be satisfied. In the above composition, for example, a requirement 0.25z≤0.80, 0.25≤z≤0.75, 0.25≤z≤0.70, 0.25≤z≤0.65, or 0.25≤z≤0.60 is satisfied.

The dielectric 10 may include only Bi₂Ti₂O₇ as a crystalline oxide, or may include a crystalline oxide other than Bi₂Ti₂O₇. The dielectric 10 includes, for example, at least one selected from the group consisting of crystalline Bi₄Ti₃O₁₂, crystalline γ—Bi₂O₃, and crystalline Bi(Mg_{0.5}Ti_{0.5})O₃. In this case, the dielectric 10 is more likely to have an increased dielectric constant under conditions of high electric field strength.

The dielectric 10 may include at least one selected from the group consisting of crystalline Bi₄Ti₃O₁₂ and crystalline γ—Bi₂O₃. In this case, the dielectric 10 is more likely to have an increased dielectric constant under conditions of high electric field strength.

The dielectric 10 may include crystalline γ—Bi₂O₃. In this case, the dielectric 10 is more likely to have an increased dielectric constant under conditions of high electric field strength.

For example, at an electric field strength of 0.5 MV/cm, the dielectric 10 has a dielectric constant of more than 138 when the electric field strength is increased, and the dielectric 10 has a dielectric constant of more than 100 when the electric field strength is decreased. In this case, the dielectric 10 has a high dielectric constant at a high electric field strength of 0.5 MV/cm, and the capacitor 1a is likely to have an increased capacitance under conditions of high electric field strength.

For example, at an electric field strength of 0.5 MV/cm, the dielectric 10 may have a dielectric constant of 140 or more, 150 or more, or 160 or more when the electric field strength is increased. For example, at an electric field strength of 0.5 MV/cm, the dielectric 10 may have a dielectric constant of 110 or more, 115 or more, or 120 or more when the electric field strength is decreased. At an electric field strength of 0.5 MV/cm, when the electric field strength is increased and when the electric field strength is decreased, the dielectric 10 has a dielectric constant of, for example, 2000 or less and may have a dielectric constant of 1500 or less or 1000 or less. At an electric field strength of 0.5 MV/cm, the dielectric 10 has a dielectric constant of, for example, more than 138 and 2000 or less, 1500 or less, or 1000 or less when the electric field strength is increased. At an electric field strength of 0.5 MV/cm, the dielectric 10 has a dielectric constant of, for example, more than 100 and 2000 or less, 1500 or less, or 1000 or less when the electric field strength is decreased.

For example, at an electric field strength of 0.7 MV/cm, the dielectric 10 has a dielectric constant of more than 138 when the electric field strength is increased, and the dielectric 10 has a dielectric constant of more than 57 when the electric field strength is decreased. In this case, the dielectric 10 has a high dielectric constant at a high electric field strength of 0.7 MV/cm, and the capacitor 1a is likely to have an increased capacitance under conditions of high electric field strength.

For example, at an electric field strength of 0.7 MV/cm, the dielectric 10 may have a dielectric constant of 140 or more, 150 or more, or 160 or more when the electric field strength is increased. For example, at an electric field strength of 0.7 MV/cm, the dielectric 10 may have a dielectric constant of 60 or more, 80 or more, or 100 or more when the electric field strength is decreased. At an electric field strength of 0.7 MV/cm, when the electric field strength is increased and when the electric field strength is decreased, the dielectric 10 has a dielectric constant of, for example, 2000 or less and may have a dielectric constant of 1500 or less or 1000 or less. At an electric field strength of 0.7 MV/cm, the dielectric 10 has a dielectric constant of, for example, more than 138 and 2000 or less, 1500 or less, or 1000 or less when the electric field strength is increased. At an electric field strength of 0.7 MV/cm, the dielectric 10 has a dielectric constant of, for example, more than 57 and 2000 or less, 1500 or less, or 1000 or less when the electric field strength is decreased.

The dielectric 10 is not limited to any particular shape. The dielectric 10 forms, for example, a film. A method for forming the film is not limited to any particular method. The film may be formed, for example, by vapor phase deposition or by anodic oxidation. The dielectric 10 forms, for example, at least one film selected from the group consisting of a pulsed laser deposition (PLD) film, a vacuum deposition film, a sputtering film, an atomic layer deposition (ALD) film, a chemical vapor deposition film (CVD), and an anodic oxide film. In this case, the dielectric 10 is more likely to have an increased dielectric constant under conditions of high electric field strength. In addition, the values of x, y, and z in the composition represented by Bi₂ₓMg_{y}Ti_{z}Oₖ are likely to be adjusted to desired ranges.

As shown in FIG. 1, the capacitor 1a includes a first electrode 21, the dielectric 10, and a second electrode 22. The dielectric 10 is disposed on the first electrode 21. The second electrode 22 covers at least a portion of the dielectric 10. Since the capacitor 1a includes the dielectric 10, the capacitor 1a is likely to exhibit a high capacitance under conditions of high electric field strength.

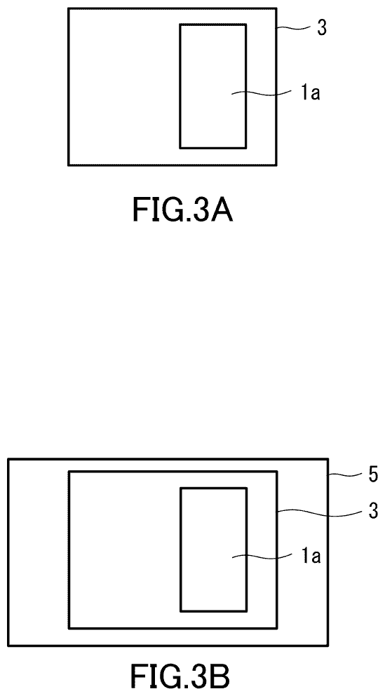

FIG. 2 is a cross-sectional view showing another example of the capacitor of the present disclosure. A capacitor 1b shown in FIG. 2 is configured in the same manner as the capacitor 1a unless otherwise described. Components of the capacitor 1b that are the same as or correspond to the components of the capacitor 1a are denoted by the same reference characters, and the detailed description is omitted. The description for the capacitor 1a also applies to the capacitor 1b unless there is a technical inconsistency.

As shown in FIG. 2, at least a portion of the first electrode 21 included in the capacitor 1b is porous. With such a configuration, the first electrode 21 is likely to have an increased surface area and the capacitor 1b is likely to have an increased capacitance. Such a porous structure can be formed, for example, by etching of a metal foil or sintering of a powder.

As shown in FIG. 2, for example, a film of the dielectric 10 is formed on the surface of the porous portion of the first electrode 21. In this case, an adoptable film formation method for the dielectric 10 is atomic layer deposition (ALD) or a chemical vapor deposition method, such as CVD or mist CVD.

The first electrode 21 includes, for example, a valve metal, such as Al, Ta, Nb, Zr, Hf, or Bi. The second electrode 22 may include, for example, a solidified product of a silver-containing paste, a carbon material, such as graphite, or both the above solidified product and carbon material.

The capacitors 1a and 1b may be electrolytic capacitors. In this case, for example, an electrolyte 23 is disposed between the first electrode 21 and the second electrode 22. The electrolyte 23 may be disposed between the dielectric 10 and the second electrode 22. In the capacitor 1b, the electrolyte 23 is disposed, for example, to fill the space around the porous portion of the first electrode 21.

The electrolyte 23 includes, for example, at least one selected from the group consisting of manganese oxide, an electrolyte solution, and an electrically conductive polymer. Examples of the electrically conductive polymer include polypyrrole, polythiophene, polyaniline, and derivatives of these polymers. The electrolyte 23 may be made of a manganese compound, such as manganese oxide. The electrolyte 23 may include a solid electrolyte.

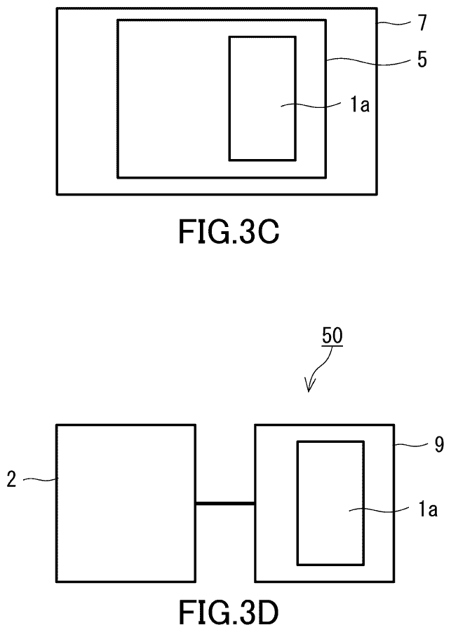

For example, it is possible to provide an electrical circuit including the capacitor 1a or 1b. FIG. 3A schematically shows an example of an electrical circuit of the present disclosure. An electrical circuit 3 includes the capacitor 1a. The electrical circuit 3 may be an active circuit or a passive circuit. The electrical circuit 3 may be a discharge circuit, a smoothing circuit, a decoupling circuit, or a coupling circuit. Since the electrical circuit 3 includes the capacitor 1a, the electrical circuit 3 is likely to exhibit a desired performance when the capacitor 1a is used under conditions of high electric field strength. The electrical circuit 3 may include the capacitor 1b.

For example, it is possible to provide a circuit board including the capacitor 1a or 1b. FIG. 3B schematically shows an example of a circuit board of the present disclosure. As shown in FIG. 3B, a circuit board 5 includes the capacitor 1a. For example, on the circuit board 5, an electrical circuit including the capacitor 1a is formed. Since the circuit board 5 includes the capacitor 1a, the circuit board 5 is likely to exhibit a desired performance when the capacitor 1a is used under conditions of high electric field strength. The circuit board 5 may include the capacitor 1b.

For example, it is possible to provide an apparatus including the capacitor 1a or 1b. FIG. 3C schematically shows an example of an apparatus of the present disclosure. As shown in FIG. 3C, an apparatus 7 includes the capacitor 1a. The apparatus 7 includes, for example, the circuit board 5 including the capacitor 1a. Since the apparatus 7 includes the capacitor 1a, the apparatus 7 is likely to exhibit a desired performance when the capacitor 1a is used under conditions of high electric field strength. The apparatus 7 may include the capacitor 1b. The apparatus 7 may be an electronic device, a communication device, a signal processing device, a power supply device, an inverter, or a converter. The apparatus 7 may be a server, an AC adapter, an accelerator, or a flat-panel display, such as a liquid crystal display (LCD). The apparatus 7 may be a USB charger, a solid-state drive (SSD), an information terminal, such as a PC, a smartphone, or a tablet PC, or an Ethernet switch.

For example, it is possible to provide an energy storage device including the capacitor 1a or 1b. FIG. 3D schematically shows an example of an energy storage device of the present disclosure. As shown in FIG. 3D, an energy storage device 9 includes the capacitor 1a. With this configuration, the energy storage device 9 is likely to exhibit a desired performance when the capacitor 1a is used under conditions of high electric field strength. The energy storage device 9 may include the capacitor 1b. As shown in FIG. 3D, for example, it is possible to provide an energy storage system 50 by using the energy storage device 9. The energy storage system 50 includes the energy storage device 9 and a power generation apparatus 2. In the energy storage system 50, electricity obtained from power generation in the power generation apparatus 2 is stored in the energy storage device 9. The power generation apparatus 2 is, for example, an apparatus for solar power generation or wind power generation. The energy storage device 9 includes, for example, a secondary battery, such as a lithium-ion battery or a lead-acid battery.

### EXAMPLES

The present disclosure is described below in more detail on the basis of examples. However, the present disclosure is not limited to the following examples.

### Examples 1 to 5 and Comparative Examples 2 to 7

Sputtering was performed using Pt as the target to form a thin Pt film on an Al₂O₃(0001) substrate, obtaining a lower electrode. The thin Pt film was in contact with the substrate. In the sputtering, the substrate environment was maintained at 0.3 Pa with argon gas occupying 100% of the volume. Additionally, the substrate temperature was adjusted to 500° C.

PLD films of samples according to Examples 1 to 5 and Comparative Examples 2 to 7 were formed on the lower electrodes by PLD using Bi₂O₃, MgO, and TiO₂ as the targets. The PLD conditions were adjusted so that the PLD films would have a thickness of 100 nm. In the PLD, the substrate environment was maintained at a pressure of 0.01 Pa with oxygen gas occupying 100% of the volume. Additionally, the substrate was not heated. The composition ratio among Bi, Mg, and Ti in the dielectric film according to each of the samples was controlled by adjusting the film formation time, which involved opening and closing the shutter. Subsequently, the PLD film was heat-treated at 640° C. for 2 minutes in an environment consisting of 80 volume % argon gas and 20 volume % oxygen gas using a variable atmosphere lamp annealing system VHC-P616C manufactured by ADVANCE RIKO, Inc. Thus, the dielectric films according to Examples 1 to 5 and Comparative Examples 2 to 7 were obtained. Next, sputtering was performed using Pt as the target to form a thin Pt film with a diameter of 100 μm and a thickness of 100 nm on each of the dielectric films, obtaining an upper electrode. The samples according to Examples 1 to 5 and Comparative Examples 2 to 7 were thus obtained.

### (Identification of Composition)

Before the formation of the upper electrode, X-ray fluorescence analysis was performed on the dielectric film according to each of the samples using an X-ray fluorescence spectrometer micro EDX-1400 manufactured by Shimadzu Corporation, and quantitative analysis of the elements in the dielectric film was performed. The method adopted for the quantitative analysis was a fundamental parameter method (FP method). From the results of the quantitative analysis, the ratio in terms of number of atoms among Bi, Mg, and Ti in the dielectric film according to each of the samples was determined. The results are shown in Table 1. In Table 1, x represents the half value of the number of Bi atoms/(the half value of the number of Bi atoms+ the number of Mg atoms+ the number of Ti atoms); y represents the number of Mg atoms/(the half value of the number of Bi atoms+ the number of Mg atoms+ the number of Ti atoms); and z represents the number of Ti atoms/(the half value of the number of Bi atoms+ the number of Mg atoms+ the number of Ti atoms).

### (Evaluation of Crystalline Phase)

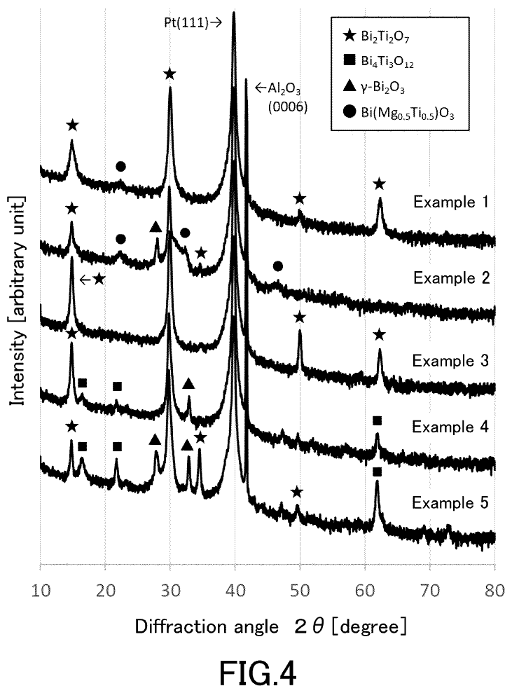

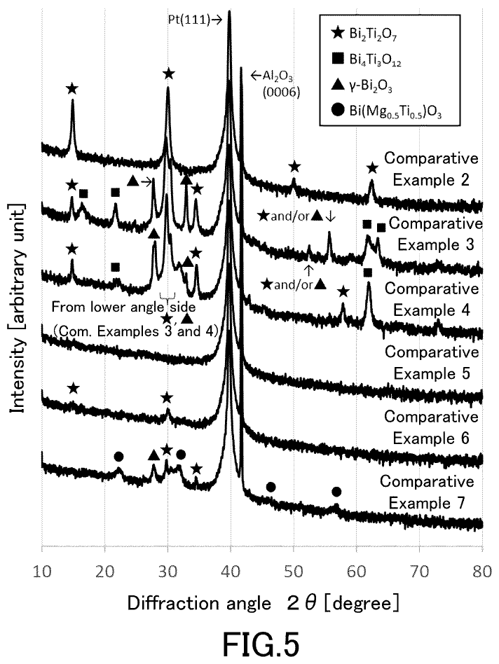

Before the formation of the upper electrode, X-ray diffraction measurement was performed on the dielectric film according to each of the samples using an X-ray diffractometer D8 Discover manufactured by Bruker Corporation, and the XRD pattern of the dielectric film was obtained through 2θ/θscanning. FIG. 4 shows the XRD patterns of the dielectric films of the samples according to Examples 1 to 5. FIG. 5 shows the XRD patterns of the dielectric films of the samples according to Comparative Examples 2 to 7. In FIGS. 4 and 5, the vertical axis represents the diffraction intensity in arbitrary units on a logarithmic scale, while the horizontal axis represents the diffraction angle 2θ. The vertical axis in FIGS. 4 and 5 shows the relative relationship of diffraction intensity in a single XRD pattern and does not show the relative relationship of diffraction intensity between different XRD patterns. In this measurement, Cu-Kα radiation was used as the X-ray source, the voltage was adjusted to 50 kV, and the current was adjusted to 100 mA. The measurement was performed using a two-dimensional detector, and the results were converted to 2θ.

### (Dielectric Properties)

The dielectric film according to each of the samples was subjected to measurement of the dependence of the polarization density on the electric field strength at a frequency of 10 kHz using a ferroelectric tester The Precision Premier II manufactured by RADIANT TECHNOLOGIES, Inc. The dielectric constant at a specific electric field strength was calculated from the differential capacitance (change in polarization density per unit change in electric field strength) at the specific electric field strength, based on the values of the dielectric film thickness and the electrode area. The ambient temperature during the measurement was 25° C. The results are shown in Table 1. In Table 1, the notation “OL” indicates that dielectric breakdown occurred, resulting in a failure in calculating the dielectric constant.

For the purpose of establishing a standard for evaluating the dielectric constant, a barium titanate-based multilayer ceramic capacitor was prepared as Comparative Example 1. This multilayer ceramic capacitor is model number GRM188D71A106MA73D manufactured by Murata Manufacturing Co., Ltd., with a capacitance of 10 μF, a withstand voltage of 10 V, and dimensions of 1.6×0.8×0.8 mm. The above ferroelectric tester was used to perform measurement for the dependence of the polarization density on the electric field strength at a frequency of 10 kHz within the withstand voltage range. The cross section of the multilayer ceramic capacitor according to Comparative Example 1 was observed using a scanning electron microscope (SEM). Thus, the thickness of the dielectric and the surface area of the electrode were determined, and the dielectric constant of the dielectric of the multilayer ceramic capacitor according to Comparative Example 1 was calculated by the same procedure as above. The results are shown in Table 1.

In the multilayer ceramic capacitor according to Comparative Example 1, at an electric field strength of 0.5 MV/cm, the dielectric had a dielectric constant of 138 when the voltage was increased, and the dielectric had a dielectric constant of 100 when the voltage was decreased. Increasing the voltage increases the electric field strength. Decreasing the voltage decreases the electric field strength. In the multilayer ceramic capacitor according to Comparative Example 1, at an electric field strength of 0.7 MV/cm, the dielectric had a dielectric constant of 138 when the voltage was increased, and the dielectric had a dielectric constant of 57 when the voltage was decreased. The dielectric constant of capacitor dielectrics under high-voltage conditions is often evaluated at electric field strengths of approximately several tens of kV/cm. On the other hand, evaluation of the dielectric constant of capacitor dielectrics at the above electric field strengths is considered insufficient for achieving miniaturization of capacitors to which several hundred volts of DC voltages can be applied. Such capacitors are, for example, capacitors used in automotive converters and automotive inverters. In view of this, considering the withstand voltage of the multilayer ceramic capacitor according to Comparative Example 1, the dielectric constant of the dielectric was evaluated at electric field strengths of 0.5 MV/cm and 0.7 MV/cm as described above, which are approximately 10 times higher than the electric field strength of approximately several tens of kV/cm.

As shown in Table 1, in each of the samples according to Examples 1 to 5, the dielectric constant of the dielectric film at 0.5 MV/cm exceeded 138 when the voltage was increased, and the dielectric constant of the dielectric film at 0.5 MV/cm exceeded 100 when the voltage was decreased. In addition, in each of the samples according to Examples 1 to 5, the dielectric constant of the dielectric film at 0.7 MV/cm exceeded 138 when the voltage was increased, and the dielectric constant of the dielectric film at 0.7 MV/cm exceeded 57 when the voltage was decreased. In contrast, in each of the samples according to Comparative Examples 2 to 7, the dielectric constant of the dielectric film satisfied at least one of the following requirements (i), (ii), (iii), and (iv): (i) the dielectric constant at 0.5 MV/cm is 138 or less when the voltage is increased; (ii) the dielectric constant at 0.5 MV/cm is 100 or less when the voltage is decreased; (iii) the dielectric constant at 0.7 MV/cm is 138 or less when the voltage is increased; and (iv) the dielectric constant at 0.7 MV/cm is 57 or less when the voltage is decreased.

As shown in FIGS. 4 and 5, in the XRD pattern of the dielectric film of each of the samples according to Examples 1 to 5 and Comparative Examples 2 to 7, a peak is observed near each of 14.8°, 16.5°, 21.8°, 22.3°, 28.0°, 29.9°, 30.3°, 31.8°, 32.8°, 34.5°, 46.2°, 50.0°, 52.3°, 55.8°, 56.5°, 57.8°, 61.9°, 62.3°, and 63.5°. Among these peaks, the peaks at 14.8°, 29.9°, 34.5°, 50.0°, 57.8°, and 62.3° are attributed to Bi₂Ti₂O₇. The peaks near 16.5°, 21.8°, 61.9°, and 63.5° are attributed to Bi₄Ti₃O₁₂. The peaks near 28.0°, 30.3°, and 32.8° are attributed to γ—Bi₂O₃. The peaks near 22.3°, 31.8°, 46.2°, and 56.5° are attributed to Bi (Mg_{0.5}Ti_{0.5})O₃. Furthermore, the peaks near 52.3° and 55.8° are attributed to at least one selected from the group consisting of Bi₂Ti₂O₇ and γ—Bi₂O₃. In this connection, peaks are also observed near 39.8° and 41.7° but are respectively attributed to Pt in the lower electrode and Al₂O₃ in the substrate. These peaks are irrelevant to the components of the dielectric film. The presence or absence of the crystalline phases in the dielectric films of the samples according to Examples 1 to 5 and Comparative Examples 2 to 7 is shown in Table 1. The dielectric films of the samples according to Examples 1 to 5 included Bi₂Ti₂O₇. In addition, the dielectric films of the samples according to Examples 1, 2, 4, and 5 each included at least one selected from the group consisting of Bi₄Ti₃O₁₂, γ—Bi₂O₃, and Bi(Mg_{0.5}Ti_{0.5})O₃.

From the above, it is indicated that a dielectric satisfying both the following requirements (I) and (II) is likely to have a high dielectric constant under conditions of high electric field strength:
(I) the dielectric has a composition represented by Bi₂ₓMg_{y}Ti_{z}Oₖ, and this composition satisfies requirements x≥0.15, y≤0.40, z≥0.25, and x+y+z=1.0; and
(II) the dielectric includes crystalline Bi₂Ti₂O₇.

From the above description, many improvements and other embodiments of the present disclosure are apparent to those skilled in the art. Accordingly, the above description should be construed as illustrative only and is provided for the purpose of teaching those skilled in the art the best modes for carrying out the present disclosure. The present disclosure can be substantially modified in terms of operating conditions, composition, structure, and/or function thereof, without departing from the spirit of the present disclosure.

TABLE 1

| | Ratio | | | Dielectric constant | | Dielectric constant | | | | | |
|---|---|---|---|---|---|---|---|---|---|---|---|
| | in number of atoms | | | @0.5 MV/cm | | @0.7 MV/cm | | | | | |
| | (x + y + z = 1) | | | During | During | During | During | | | | |
| | Bi/2 | Mg | Ti | voltage | voltage | voltage | voltage | Presence or absence of crystalline phase | | | |
| | x | y | z | increase | decrease | increase | decrease | Bi₂Ti₂O₇ | Bi₄Ti₃O₁₂ | γ-Bi₂O₃ | Bi(Mg_{0.5}Ti_{0.5})O₃ |
| Ex. 1 | 0.19 | 0.36 | 0.45 | 180 | 129 | 183 | 114 | Present | Absent | Absent | Present |
| Ex. 2 | 0.27 | 0.40 | 0.33 | 588 | 180 | 858 | 144 | Present | Absent | Present | Present |
| Ex. 3 | 0.16 | 0.24 | 0.60 | 162 | 137 | 160 | 121 | Present | Absent | Absent | Absent |
| Ex. 4 | 0.31 | 0.32 | 0.37 | 328 | 162 | 386 | 141 | Present | Present | Present | Absent |
| Ex. 5 | 0.36 | 0.36 | 0.28 | 303 | 161 | 744 | 130 | Present | Present | Present | Absent |
| Comp. | BaTiO₃-based MLCC | | | 138 | 100 | 138 | 57 | — | — | — | — |
| Ex. 1 | | | | | | | | | | | |
| Comp. | 0.12 | 0.29 | 0.59 | 85 | 76 | 95 | 71 | Present | Absent | Absent | Absent |
| Ex. 2 | | | | | | | | | | | |
| Comp. | 0.43 | 0.35 | 0.23 | 72 | 50 | 109 | 43 | Present | Present | Present | Absent |
| Ex. 3 | | | | | | | | | | | |
| Comp. | 0.34 | 0.41 | 0.25 | 81 | 69 | OL | OL | Present | Present | Present | Absent |
| Ex. 4 | | | | | | | | | | | |
| Comp. | 0.04 | 0.43 | 0.53 | 63 | 64 | 56 | 49 | Absent | Absent | Absent | Absent |
| Ex. 5 | | | | | | | | | | | |
| Comp. | 0.10 | 0.45 | 0.45 | 48 | 44 | 48 | 43 | Present | Absent | Absent | Absent |
| Ex. 6 | | | | | | | | | | | |
| Comp. | 0.21 | 0.54 | 0.25 | 182 | 87 | 180 | 77 | Present | Absent | Present | Present |
| Ex. 7 | | | | | | | | | | | |

### INDUSTRIAL APPLICABILITY

The dielectric material of the present disclosure can be used in applications such as automotive capacitors.

What is claimed is:

1. A dielectric having a composition represented by Bi_{2X}Mg_{y}Ti_{z}Oₖ, wherein
the composition satisfies requirements x≥0.15, y≤0.40, z≥0.25, and x+y+z=1.0, and
in the composition, k is a value for maintaining electroneutrality.

2. The dielectric according to claim 1, comprising crystalline Bi₂Ti₂O₇.

3. The dielectric according to claim 1, comprising at least one selected from the group consisting of crystalline Bi₄Ti₃O₁₂, crystalline γ—Bi₂O₃, and crystalline Bi(Mg_{0.5}Ti_{0.5})O₃.

4. The dielectric according to claim 1, comprising at least one selected from the group consisting of crystalline Bi₄Ti₃O₁₂ and crystalline γ—Bi₂O₃.

5. The dielectric according to claim 1, comprising crystalline γ—Bi₂O₃.

6. The dielectric according to claim 1, wherein
at an electric field strength of 0.5 MV/cm, the dielectric has a dielectric constant of more than 138 when the electric field strength is increased, and the dielectric has a dielectric constant of more than 100 when the electric field strength is decreased.

7. The dielectric according to claim 1, wherein
at an electric field strength of 0.7 MV/cm, the dielectric has a dielectric constant of more than 138 when the electric field strength is increased, and the dielectric has a dielectric constant of more than 57 when the electric field strength is decreased.

8. The dielectric according to claim 1, forming at least one film selected from the group consisting of a pulsed laser deposition film, a vacuum deposition film, a sputtering film, an atomic layer deposition film, a chemical vapor deposition film, and an anodic oxide film.

9. The dielectric according to claim 1, being for a capacitor.

10. A capacitor comprising:
a first electrode,
the dielectric according to claim 1 disposed on the first electrode; and
a second electrode covering at least a portion of the dielectric.

11. An electrical circuit comprising the capacitor according to claim 10.

12. A circuit board comprising the capacitor according to claim 10.

13. An apparatus comprising the capacitor according to claim 10.

14. An energy storage device comprising the capacitor according to claim 10.
